(19) United States
(12) Patent Application Publication
(10) Pub. No.: US 2024/0340292 A1
(43) Pub. Date: Oct. 10, 2024

(54) COGNITIVE FRAMEWORK AND IMPLEMENTATION METHODS FOR BUSINESS OPERATIONS INTELLIGENCE

(71) Applicant: Netenrich, Inc., San Jose, CA (US)

(72) Inventors: Praveen Hebbagodi, Jayanagar (IN); Bikram Kachari, Assam (IN); Christopher Morales, Oakland, CA (US)

(21) Appl. No.: 18/625,046

(22) Filed: Apr. 2, 2024

Related U.S. Application Data
(60) Provisional application No. 63/494,089, filed on Apr. 4, 2023.

(51) Int. Cl. H04L 9/40

(52) U.S. Cl. CPC H04L 63/1416

(57) ABSTRACT

A ML-based architecture for network monitoring and security monitoring. Illustratively, the ML-based architecture obtains a set of inputs from a wide variety of input sources, which may be generally described as input signals. The input signals can include natural language-based instructions or statements related to network monitoring, security monitoring, or a combination thereof. The ML-based architecture can include one or more ML models, such as LLM models, that are configured to process the input signals and identify network security processing actions to be implemented by the ML-based architecture. The ML-based architecture can also include one or more ML models, such as LLM models, that are configured to process processing results from the network security processing actions and generate natural language outputs.

### CROSS-REFERENCE TO RELATED APPLICATION

This application claims the benefit of U.S. Provisional Application No. 63/494,089 entitled COGNITIVE FRAMEWORK AND IMPLEMENTATION METHODS FOR BUSINESS OPERATIONS INTELLIGENCE and filed on Apr. 4, 2023. U.S. Provisional Application No. 63/494,089 is incorporated by reference herein.

### BACKGROUND

Generally described, computing devices and communication networks can be utilized to exchange data or information. In a common application, a computing device can request content from another computing device via the communication network. For example, a client having access to a computing device can utilize a software application to interact with one or more computing devices via the network (e.g., the Internet). In such embodiments, the client's computing device can be referred to as a client computing device, and the server computing device can be referred to as a network service provider or network service.

Some network service providers can implement one or more individual services that may be configured to monitor the execution of individual services made accessible to client computing devices or utilized in servicing/interacting with client computing devices. Such network monitoring services may be configured in a manner to identify potential errors, faults, and intrusions in the execution of a network environment. Additionally, network monitoring services may be further configured to attempt to mitigate or resolve identified errors, faults and intrusions.

Network service providers may also implement one or more individual services that may be configured to monitor the interaction of client computing devices with a network environment. Such monitoring services, referred to generally as security services, may be specifically configured to identify potential communications or interactions between client devices and the network environment that would be considered to be malicious or harmful to the operation of the network environment. For example, a network security service may attempt to identify and mitigate potential malicious activity that could attempt to disrupt the operation of the network environment, gain access to unauthorized data, gain control of network-based resources, and the like.

### BRIEF DESCRIPTION OF DRAWINGS

Embodiments of various inventive features will now be described with reference to the following drawings. Throughout the drawings, reference numbers may be re-used to indicate correspondence between referenced elements. The drawings are provided to illustrate example embodiments described herein and are not intended to limit the scope of the disclosure. To easily identify the discussion of any particular element or act, the most significant digit(s) in a reference number typically refers to the figure number in which that element is first introduced.

FIG. 1 is a block diagram of a network environment that includes one or more devices associated with customer/clients that can interact with one or more network services, one or more devices associated with analysts or administrators that can also interact with one or more network services, one or more third-party services that can provide or provision input signals as described herein, and a service provider for processing or configuring machine learned algorithms for processing input signals according to one or more embodiments;

FIGS. 2A and 2B are block diagram of the network environment of FIG. 1 illustrating various interactions to process a set of inputs signals to generate processing results for various functionality described in accordance with one or more aspects of the present application;

FIG. 3 depicts one embodiment of an architecture of a natural language processing component in accordance with one or more aspects of the present application; and

FIG. 4 is a flow diagram illustrative of a routine for event signal processing.

### DETAILED DESCRIPTION

Generally described, challenges faced by traditional implementations of network management can correspond to an overload of signals and alerts from various systems. For example, receiving and managing continuous alerts increases “alert fatigue.” This can result in the system, and associated administrative personnel, overlooking critical alerts, or misinterpreting the magnitude or severity of alerts. Such instances of alert fatigue can lead to network outages in communication networks. Additionally, instances of alert fatigue can result in data breaches or other forms of security events, such as cyber-attacks, etc.

Some existing approaches in both network security and network management are predominantly rules-based systems. Such approaches may utilize some form of machine learned algorithms for provisioning such rules or in enrichment of data. In some approaches, such rules-based systems may utilize network-based data resources, often referred to as cloud environments. Such cloud environments may be configured to collect individual data from different systems and make the data available for security and management monitoring. However, setting up and continuously tuning the monitoring and observability platforms for many cloud environments can be very time consuming and typically corresponds to a high skill activity. Traditional implementations of configuration approaches for monitoring and collection systems can include manual configuration of such systems. This approach typically requires a higher degree of knowledge and skill in administrative personal and may be more vulnerable to errors or faults. Additionally, such manual configuration approaches are generally static in nature in either pre-defining the configuration of the network monitoring and collection systems. Still further, manual configuration approaches typically process larger amounts of collected data, which increases service provider costs and resource consumption in processing larger data sets. Even further, utilization of machine learned algorithms requires more detailed development and knowledge of interfaces for executing the machine learned algorithms.

With regard to implementations of network security implementations, the concept of threat modeling can be generally characterized as a process in which potential threats to the operation of a network activity can be identified and enumerated to allow for potential mitigation or countermeasures to be developed or executed. Generally described, threat modeling is considered a human intensive activity requiring a high degree of knowledge of network environments and associated security activities. Threat modeling typically involves several iterations between threat modeling teams, stake holders and architects. Some approaches to threat modeling tools correspond to simulation environments for developing and simulating potential threat activity. In a related aspect, threat hunting is another concept in which security threats are proactively identified and prioritized prior to occurrence. Generally described, by definition, threat hunting is a human driven activity, primarily focusing on identifying potential threats and confirms threat potential by processing logs and alerts from various systems. Threat hunting typically requires a high degree of skill to implement and is not generally scalable or suitable for automation.

Still further, the adoption of emerging technology has caused significant shifts in business operations, human interactions, commerce and relationships. Such emerging technologies can include machine learning (ML) models that can be optimized to receive inputs, process the inputs and generate outputs. For example, ML-based large language models (LLMs) are one form of ML model that can be optimized for processing and generating natural language based outputs. However successfully managing many emerging technologies changes can be difficult. To date, LLM (language-based) interfaces have been implemented in analytics systems as substitutes for graphical interfaces. These types of interfaces attempt to simplify the user interaction with analytics systems. But, these systems are limited to the same functionality or limitations as originally provided in the interfaces. Such exemplary limitations include (but are not limited to) requiring knowledge/configuration of the user of analytics processes provided by the analytics systems, the information sources available or accessible to the system, the outputs generated by the analytics system, and the like.

To address at least some portion of the above-identified deficiencies, one or more aspects of the present application corresponds to a ML-based architecture for network monitoring and security monitoring. Illustratively, the ML-based architecture obtains a set of inputs from a wide variety of input sources, which may be generally described as input signals. The input signals can include natural language-based instructions or statements related to network monitoring, security monitoring, or a combination thereof (generally referred to a “network security” input signals. The ML-based architecture can include one or more ML models, such as LLM models, that are configured to process the input signals and identify network security processing actions to be implemented by the ML-based architecture. The input signals can also include data sources or other input data maintained by the ML-based architecture or accessible from a third-party data source. Some portion of the input signals may be correlated into a common data repository or set of repositories.

Additionally, aspects of the present application can include the integration of a network security processing actions implemented by a cognitive framework in the ML-based architecture configured for types of activities that can be characterized as business operations intelligence. Such business operations intelligence can be focused on risk management. Illustratively, the cognitive framework utilizes organized cognitive structures or mental models to process and respond to complex information related to business operations including security, cloud and infrastructure. The implementation methods include the use of data processing architectures and ML algorithms to improve the capabilities and functionality of ML-based architecture to generate insights and inferences regarding task, goals, inputs, and the like. The ML-based architecture can specifically, in some embodiments, leverage large language models (LLM) to communicate determined insights/inferences (e.g., processing results) via human discernable dialogue to the users of the system. In accordance with this aspect, the ML-based architecture can provide for one or more dialogue interfaces based on maintained data, such as real-time data, that can eliminate or mitigate the impact and deficiencies associated with silos created by other tools and data and further based on reliance and need for specialized expertise. More detailed examples of illustrative the implementation of cognitive or mental models by the ML-based architecture are provided in U.S. patent application Ser. No. 18/326,843, entitled ADAPTIVE SYSTEM FOR NETWORK AND SECURITY MANAGEMENT, filed on May 31, 2023; U.S. patent application Ser. No. 18/326,829, entitled ADAPTIVE SYSTEM FOR NETWORK AND SECURITY MANAGEMENT, filed on May 31, 2023; U.S. patent application Ser. No. 18/326,725, entitled ADAPTIVE SYSTEM FOR NETWORK AND SECURITY MANAGEMENT, filed on May 31, 2023; U.S. patent application Ser. No. 18/326,792, entitled ADAPTIVE SYSTEM FOR NETWORK AND SECURITY MANAGEMENT, filed on May 31, 2023, and U.S. patent application Ser. No. 18/326,861, entitled ADAPTIVE SYSTEM FOR NETWORK AND SECURITY MANAGEMENT, filed on May 31, 2023. U.S. patent application Ser. Nos. 18/326,843, 18/326,829, 18/326,725, 18/326,792, and 18/326,861 are incorporated by reference in their entirety herein.

As discussed previously, in some aspects, the input signals to the ML-based architecture can be based on natural language inputs, such as collected by graphical user interfaces (such as charts or tables), spoken words, scanned images, and the like. In one example, processing results generated by the ML-based architecture can include situational awareness information or characterizations of cyber security and business risks. Such characterizations can include an assessment of risks, predicting any potential threats and recommending preventive measures. In another example, processing results generated by the ML-based architecture can include feedback/supplemental questions to provide additional context or data for processing. Such feedback/supplemental questions can include asking questions on or about the data or inferences generated from the data, which can be absorbed either in natural language (text/speech through dialogue or system-monologues), consumed by applications, triggering can be via a dialogue.

Illustratively, natural language inputs can be an effective interface when integrated with various types of data and processing actions on ML-based architecture. This integration can provide several benefits. By way of illustrative examples, in a security context, natural language (NL) based inputs allow users to provide NL-based inputs regarding various aspects of network security to the ML-based architecture that can be used to extract information, derive network security processing attributes, network security actions based on the processing attributes, and generate outputs, including NL-based outputs. The types of network security actions include, but are not limited to, queries on raw data collected by the ML-based architecture, queries on network performance metrics, queries on cognitive structures or mental models implemented by the ML-based architecture, queries on previously performed or desired network security analytics, queries on newly created analysis, metrics, etc., and various combinations or alternative thereof.

By way of non-limiting examples, the ML-based architecture can include a NL processing component that can be configured with one or more ML models for processing NL-based inputs from users (submitted in various formats). In some examples, the NL-based inputs can include queries/prompts about data contained in raw events (from the Chronicle UDM), “When did Person X login to this application last week?” or “Did any of our containers in pod-378 have IOC matches?.” In other examples, the NL-based inputs can include queries/prompts about data contained raw metrics data, e.g., “How many network IO errors did we see last week from the core-router-123?” Still further, in some examples, the NL-based inputs can include queries/prompts about data contained detections, situations, actOns, IOC matches, “Which days in the last month did we see high number of privilege escalations? Break it down by data source.”

With continued examples, in some examples, the NL-based inputs can include queries/prompts about data contained performance metrics of agents and analysts, e.g., “What's the avg response times last month on actOns?” or “What's the average load per analyst?” In still further examples, the NL-based inputs can include queries/prompts about data contained in advanced analyses such as detection coverage, security posture, risk register, and observability coverage. In yet further examples, the NL-based inputs can be utilized to generate outputs that may be considered difficult to derive directly from data sources and would require greater user knowledge develop modules to enable such analyses, e.g., “Create a detailed analyses of top 5 risky users and report any abnormal behaviors.” One skilled in the relevant art will appreciate that the disclosed examples are illustrative in nature of NL-based inputs and should not be construed as limiting to any particular format, language, structure or content of NL-based inputs.

In addition to the natural language inputs described above, inputs to the ML-based architecture can include various external sources of information. Such sources of information can include existing literature on best practices, frameworks (such as NIST), and compliance standards (such as PCI). Such external sources of information can be utilized to gain an understanding of the concepts related to cybersecurity, risk management, compliance, governance and the like. Such external sources of information can be utilized to gain an understanding, for example, using how-to guides related to specific tools and technologies, such as Chronicle, Simplify, GCP SCC, and RI. Such external sources can also be utilized to identify gaps between the concepts and existing implementations, including: existing configurations; efficacies of current approaches; and potential areas for improvement or optimization. Still further, such external sources can be utilized in understanding external threats in the context of the enterprise, including: identifying potential threats and their impact on the organization, assessing the level of risk associated with each threat, and developing strategies to mitigate the identified risks. Even further, such external sources can be utilized to maintain or expand information base about trending developments and industry news relevant to the enterprise, especially in the context of operations, such as security updates and trends, cloud computing/network resource trends, emerging technologies and their potential impact on the enterprise, industry regulations and compliance requirements, and the like.

The ML-based architecture can process input signals that can correspond to generated vectorized data. The vectorized data can be further processed, such as in accordance with one or more ML models, into clusters of alerts. The resulting clusters of alerts can then be sorted and scored, such as using a curve fitting algorithm or threat intelligence markers, illustratively without having to configure rules. The ML-based architecture can then generate processing results related to network security actions. Illustratively, the NL processing component can then generate outputs to one or more users (including the requesting user), such as utilizing a LLM model.

Although aspects of the present disclosure will be described with regard to illustrative network components, interactions, and routines, one skilled in the relevant art will appreciate that one or more aspects of the present disclosure may be implemented in accordance with various environments, system architectures, external computing device architectures, and the like. Similarly, references to specific devices, such as a client computing device, can be considered to be general references and not intended to provide additional meaning or configurations for individual external computing devices. Still further, reference to types of network services or third-party content is intended to be illustrative in nature and should not be considered limiting. Additionally, the examples are intended to be illustrative in nature and should not be construed as limiting.

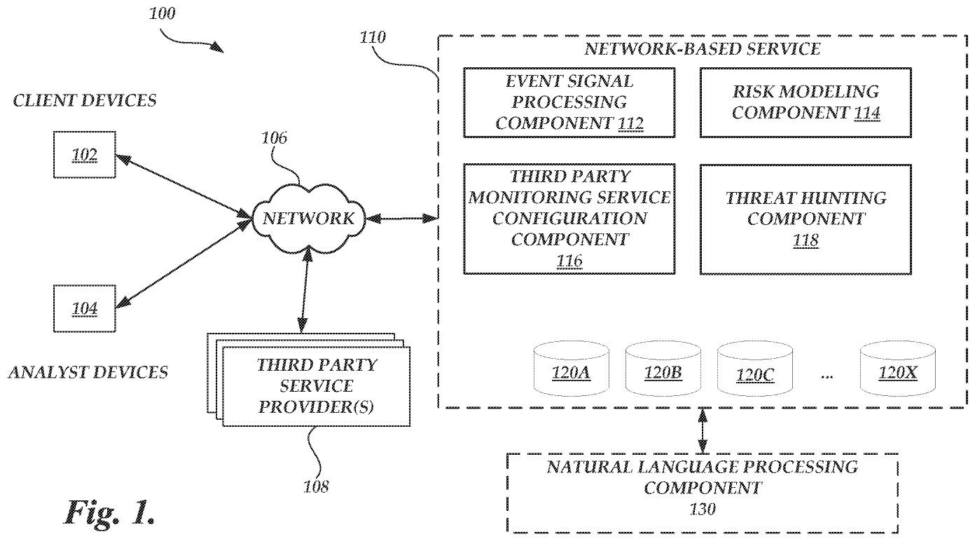

By way illustration, FIG. 1 illustrates an environment in which the natural language interfaces may be applied. The environment 100 includes a plurality of devices 102 utilized by clients or customers, generally referred to as client devices 102, to access network monitoring and security services. Client devices 102 may include any number of different computing devices capable of communicating with the network 106, via a direct connection or via an intermediary. For example, individual accessing computing devices may correspond to a laptop or tablet computer, personal computer, wearable computer, server, personal digital assistant (PDA), hybrid PDA/mobile phone, mobile phone, electronic book reader, set-top box, camera, appliance (e.g. a thermostat or refrigerator), controller, digital media player, watch, glasses, a home or car device, Internet of Thing (“IoT”) devices, virtual reality or augmented reality devices, and the like.

The environment 100 includes a plurality of devices 104 or network of devices utilized by individual analysts or system administrators, generally referred to as analyst computing devices 104, to interact with one or more of the network services described herein. Similar to client computing devices 102, the analyst computing devices 104, may include any number of different computing devices capable of communicating with the network 106, via a direct connection or via an intermediary. For example, the analyst computing devices 104 may also correspond to a laptop or tablet computer, personal computer, wearable computer, server, personal digital assistant (PDA), hybrid PDA/mobile phone, mobile phone, Internet of Thing (“IoT”) devices, virtual reality or augmented reality devices, and the like. Each of the analyst devices 104 may optionally include one or more data stores (not shown in FIG. 1) including various applications or computer-executable instructions, such as web browsers or media player software applications, used to implement the embodiments disclosed herein.

Network 106 may be any wired network, wireless network, or combination thereof. In addition, the network 106 may be a personal area network, local area network, wide area network, cable network, fiber network, satellite network, cellular telephone network, data network, or combination thereof. In the example environment of FIG. 1, network 106 is a global area network (GAN), such as the Internet Protocols and components for communicating via the other aforementioned types of communication networks that are well known to those skilled in the art of computer communications and thus, need not be described in more detail herein. While each of the client devices 102, the analyst devices 104, and the network-based service 110 are depicted as having a single connection to the network 106, individual components of the client devices 102, the analyst devices 104, and the network-based service 110 may be connected to the network 106 at disparate points. Accordingly, communication times and capabilities may vary between the components of FIG. 1. Likewise, although FIG. 1 is illustrated as having a single network 106, one skilled in the relevant art will appreciate that the environment 100 may utilize any number or combination of networks.

As further illustrated in FIG. 1, the environment further includes one or more third-party service providers 108 that can host network environments on behalf of customers, such as users corresponding to client computing devices 102. The third-party service providers 108 can further host one or more network services that can collect and collate input signals utilized by the network services. Such collected and collated input signals can include log files, performance metric information, alert data, configuration data, trace data, and the like. Individual third-party providers may include interfaces for receiving configuration information regarding the collection of information, such as processing rules or settings. The third-party providers may also provide interfaces, such as application protocol interfaces (APIs) that can transmit input signals to the network services, as described in various embodiments herein. The third-party service providers 108 can illustratively correspond to network monitoring services or security monitoring services, or a combination thereof. In accordance with aspects of the present application, the implementation of the third-party service providers 108 may be independent of the network-based service 110 such that operation of the network-based service 110 may be considered agnostic to the service providers 108. Additionally, in some embodiments, the network-based service 110 may implement or interact with third-party service providers 108 according to a multi-tenant implementation in which multiple third-party service providers may be utilized to provide input data. Other embodiments may include specific optimization or configurations unique to individual third-party service providers or sets of third-party service providers.

The third-party service providers 108 are logically illustrated as single components for purposes of simplicity. Illustratively, each individual third-party service provider 108 may be implemented in a number of different instantiated components, including virtualized resources. Accordingly, each third-party service provider 108 may correspond to a plurality of devices or virtual machine instances that are configured to implement different types of recommendations.

In accordance with embodiments, the network-based service 110 includes one or more servers for receiving content from the client devices 102 for processing input signals from the third-party service providers 108 and generating one or more additional network or security related functions. As described in further detail below, the network-based service 110 includes an event signal processing component 112, a threat modeling processing component 114, a third-party monitoring services configuration component 116, and a threat hunting processing component 118. The event signal processing component 112 includes illustrative components for configuring one or more machine learning models to analyze input signals and generate attributes of vectors characterizing and sorting the inputs signals. The threat modeling processing component 114 includes illustrative components for configuring one or more machine learning models to utilize the input signal vectors to generate models related to characterization of value of assets and likelihood of threats in assessment of network environment risk as described herein. The third-party monitoring services configuration component 116 includes illustrative components for configuring one or more machine-learned algorithms for configuration of third-party content sources related to input sources as describe herein. The threat hunting processing component 118 can correspond to machine-learned algorithms for generating configurations for third-party service providers 108 to select the configurations for generating various input signals used in one or more aspects of the present application. The threat hunting processing component 118 includes illustrative components for configuring machine-learned models for development and analysis of hypothesis as described herein. Although the various service components 112-118 associated with the network-based service 110 are illustrated as single components, each individual service component 112-118 may be implemented in a number of different instantiated components, including virtualized resources.

The network-based service 110 further can include a number of data stores 120A-120X for maintaining different information related to the execution and processing results generated by each of the individual network service components 112-118 and the network-based service 110 in general. Although illustrated or referred to as individual data stores, the data stores can correspond to multiple data stores, distributed data stores, or variations thereof.

In accordance with still further applications of the present application for security-based services, the network-based service 110 of the ML-based architecture can include a multi-level approach to automating threat modeling. Illustratively, the multi-level approach includes modeling of entry points of attackers for a network environment. The entry points can illustratively include information based on identifiable entities (e.g., people and identities) and information based on infrastructure and digital assets. The multi-level approach further includes modeling of high value assets which are targets for the attackers. Illustratively, a characterization of value (e.g., high value, low value, etc.) can be based on characterization of the likely impact to the network environment based on a successful attack/disruption.

In accordance with still further applications of the present application for security-based services, the multi-level approach can further include emulation of the modeled adversary behavior to determine the attack paths to targets within the architecture. Illustratively, the modeled attack paths correspond to a combination of the modeled entry points and value targets, such as entities including users, machines, certificates etc. that are part of the attack path. Some of these entities can be marked as critical based on its blast-radius using graph analytics algorithms, e.g., high value targets. The modeled attack paths can also identify potential additional or dependent steps that would need to be completed to complete the attack or otherwise escalate the severity of the attack.

Finally, in accordance with still further applications of the present application for security-based services, the illustrative multi-level approach incudes scoring attack paths that meet a threshold. The threshold can be added as part of the attack graph for the organizations and can be used to analyze and determine the current cyber situational awareness, which includes key metrics like least time to compromise, high value targets, etc.

With continued reference to FIG. 1, the environment 100 can include a natural language processing component 130 to process natural language based inputs and generate network security processing parameters based on application of a first machine learning model and identify one or more network security actions implemented by the network-based service 110. Illustratively, the network security processing actions are based on the generated network security processing parameters. The natural language processing component 130 can then transmit instructions to the network-based service 110 to implement one or more network security processing actions by the network-based service 110 and generate responsive processing results. The natural language processing component 130 can then process the generated processing results and generate natural-language based outputs based on application of a second machine learning model.

It will be appreciated by those skilled in the art that the environment 100 may have fewer or greater components than are illustrated in FIG. 1. Thus, the depiction of the environment 100 in FIG. 1 should be taken as illustrative. For example, in some embodiments, components of the network-based service 110 or the natural language processing component 130 may be executed by one more virtual machines implemented in a hosted computing environment. A hosted computing environment may include one or more rapidly provisioned and released computing resources, which computing resources may include computing, networking or storage devices.

Additionally, while such components are illustrated as logically grouped in FIG. 1, one skilled in the relevant art will appreciate that one or more aspects of the present application can include the network-based service 110 as being implemented in multiple geographic areas. Additionally, not all geographic areas hosting portions of the network-based service 110 will necessarily have all the same components or combination of components. Similarly, the natural language processing component 130 may be illustrated as logically separate from the network-based service 110 for purposes of illustration. The natural language processing component 130 and network-based service 110 may be implemented in various ways regardless of the logical representation in FIG. 1.

By way of illustration, reference to the above components and the system in general refers to one or more machine learning algorithms or machine-learned algorithms. By way of non-limiting examples, the machine learning algorithms can incorporate different learning models, including, but not limited to, a supervised learning model, an unsupervised learning model, a reinforcement learning model, or a featured learning model. Depending on the type of learning model adopted by the machine learning algorithm, the configuration for processing input signals data (e.g., using a training set for a supervised or semi-supervised learning model) may vary. For example, in some embodiments, a supervised learning model may relate to implementation of a large language model (LLM) that is trained in a manner to process sequentially organized data (such as natural language inputs) and generate outputs. Illustratively, leverage of the LLM language model includes separating distinct characterization of inputs, such as formal linguistic competencies, functional linguistic competencies, reasoning, world knowledge, and the like. Illustratively, the ML-based architecture platform can be configured with modules of a proposed cognitive framework for situational awareness and cyber security. Illustratively, the ML-based architecture can characterize or determine role based on inputted signals. Such signals can include, in some embodiments, a platform role of the user that is defined or pre-configured, specific information maintained in the system, history of conversations, and the like.

Additionally, different processing results, such as vectorized data, clustering, etc. will be more conducive to other types of machine-learned algorithms. In other embodiments, the machine learning algorithm can implement a reinforcement-based learning model that implements a penalty/reward model determined by a network service (e.g., an offline process). Accordingly, reference to machine-learning algorithms (not optimized) or machine learned algorithms (at least partially optimized) is not intended to reference any particular type of algorithm, training methodology (if applicable) or specific configuration.

In accordance with aspects of the present application, the ML-based architecture can include functionality that continuously fine tunes and configures network monitoring and collection systems. Illustratively, the network monitoring and collection systems can collect and provide the inputs signals, as described above. As previously described, traditional implementations of configuration approaches for monitoring and collection systems can include manual configuration of such systems. This approach typically requires higher degree of knowledge and skill in administrative personal and may be more vulnerable to errors or faults. Additionally, such manual configuration approaches are generally static in nature in either pre-defining the configuration of the network monitoring and collection systems. Still further, manual configuration approaches typically process larger amounts of collected data, which increases service provider costs and resource consumption in processing larger data sets. This also reduces the usage of these monitoring tools to focus on measuring what matters most for an organization, bringing down the operational costs of tools and monitoring efforts.

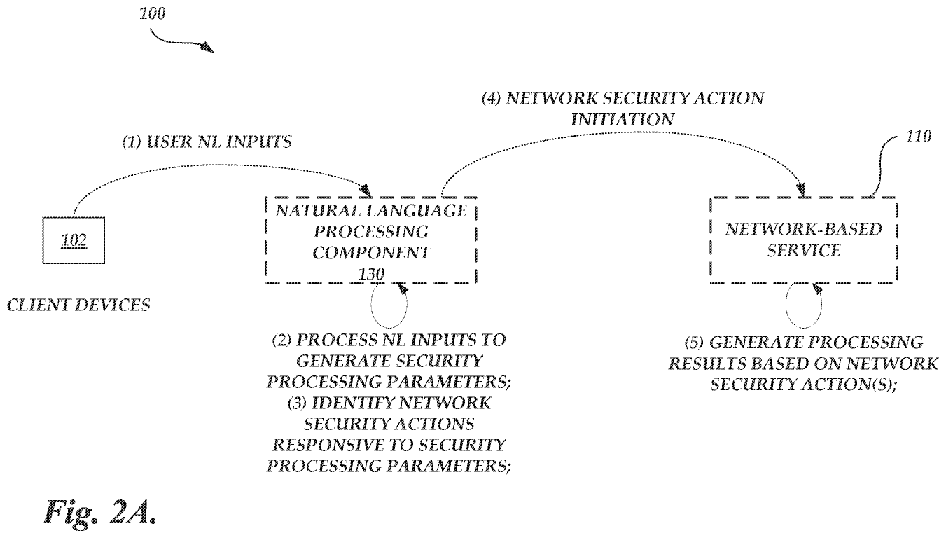

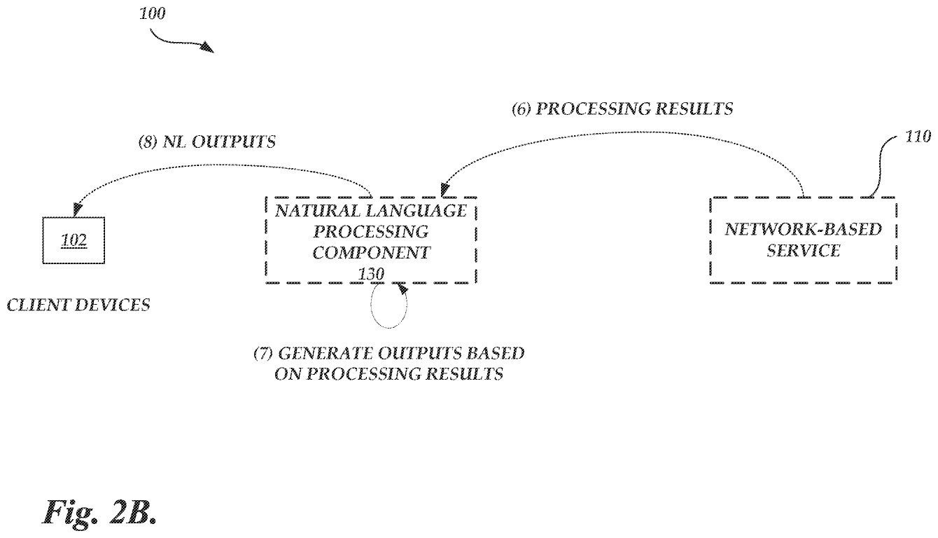

FIGS. 2A and 2B are block diagrams of the network environment 100 of FIG. 1 illustrating various interactions to process a set of inputs signals to generate processing results for various functionality described in accordance with one or more aspects of the present application. receiving a natural language-based inputs. At (1), the natural language processing component 130 obtains natural language inputs from a client device 102. As previously discussed, by way of illustrative examples, in a security context, natural language inputs allow users to provide NL inputs regarding various aspects of network security to the ML-based architecture that can be used to extract information, derive network security processing attributes, network security actions based on the processing attributes, and generate outputs, including NL outputs. The types of network security actions include, but are not limited to, queries on raw data collected by the ML-based architecture, queries on network performance metrics, queries on cognitive structures or mental models implemented by the ML-based architecture, queries on previously performed or desired network security analytics, queries on newly created analysis, metrics, etc., and various combinations or alternative thereof.

At (2), the natural language processing component 130 processes the natural language inputs and generates network security processing parameters based on application of a first machine learning model. Illustratively, network security processing parameters can correspond to a variety of information that can be extracted or correlated from the natural language inputs. The network security processing parameters to extract from the NL inputs can include data sources, objects, breakdowns, criteria/filters, timing information, breakdowns, actions, metrics, and the like. Accordingly, in some embodiments, the network security processing parameters include an identification of one or more data sources to be accessed by the network service. In other embodiments, the network security processing parameters include an identification of at least one network security processing action to be implemented by the network service. In still other embodiments, the network security processing parameters include an identification of criteria for searching data sources accessed by the network service. Still further, the network security processing parameters include an identification of an output to be generated in response to the natural language input. By way of illustration, the processing of the natural language inputs allows for the specification of workflows and actions related to network security data and analytics. The first machine learning model may be a LLM.

At (3), the natural language processing component 130 identifies one or more network security actions based on the identified network security processing parameters. Illustratively, the one or more network security actions can be correlated with identified network security processing parameters to allow the natural language processing component 130 to transmit a set of requests to the network-based service 110. For example, the network security actions can include the generation of criteria or search commands that can elicit lexical search, semantic search, and knowledge summarization of data stores or information accessible to the network service. The natural language processing component 130 can, for example, supplement NL inputs to provide additional or alternative context for the network security actions by adding additional information from user profiles, external information, historical records, and the like. The one or more security actions can also be correlated to the NL inputs by identifying the type of output generated by different processes implemented the network-based service 110 as desired or necessary to be responsive to the NL input. The one or more security actions can also include specific configurations of available analytics provided by the network-based service 110 or the generation of new or alternative analytics. Illustratively, the natural language processing component 130 can implement various ML models that can receive the network security processing parameters as inputs and generate the network security actions (including commands, configurations, identifiers, etc.) as outputs.

At (4), the natural language processing component 130 causes implementation of one or more network security actions implemented by the network-based service 110. Illustratively, the natural language processing component 130 can transmit or access the network-based service 110 via one or more application programming interfaces (APIs). Illustratively, the implementation of the one or more network security actions by the network-based service 110 causes the generation of processing results at (5). The processing results can generally represent any type of output or additional action that is generated based on the submission of the request to the network-based service 110. In the process illustrated in FIG. 2A, the processing result is a singular network security action generated by the network-based service 110. However, in other embodiments, the initial processes of the network security actions can cause the network-based service 110 to implement additional or repetitive processes, such as utilizing the outputs from a first set of network security actions as inputs to a second set of network security actions, etc. One skilled in the relevant art will appreciate, however, that the identified network security actions are illustrative in nature and should not be construed as limiting.

Turning now to FIG. 2B, at (6), the natural language processing component 130 receives or access the outputs from the network-based service 110. At (7), the natural language processing component 130 generates natural-language based outputs based on application of the processing results according to a second machine learning model. Illustratively, network security processing parameters can correspond to a variety of information that can be extracted or correlated from the natural language inputs. The outputs generated by the natural language processing component 130 can include various forms of structured text, data tables, graphs, images, videos, and the like. The outputs can also be processed based on role of the individual, such as for filtering information according to data rights, permissions, or authentications, organizing the data based on a decision making responsibility (e.g., presenting information according to the decision that is to be elicited), personal preferences, legal requirements (e.g., regulatory requirements), and the like. The second machine learning model may be an LLM. At (8), the NL outputs can be presented or provided to a user via a client computer 102.

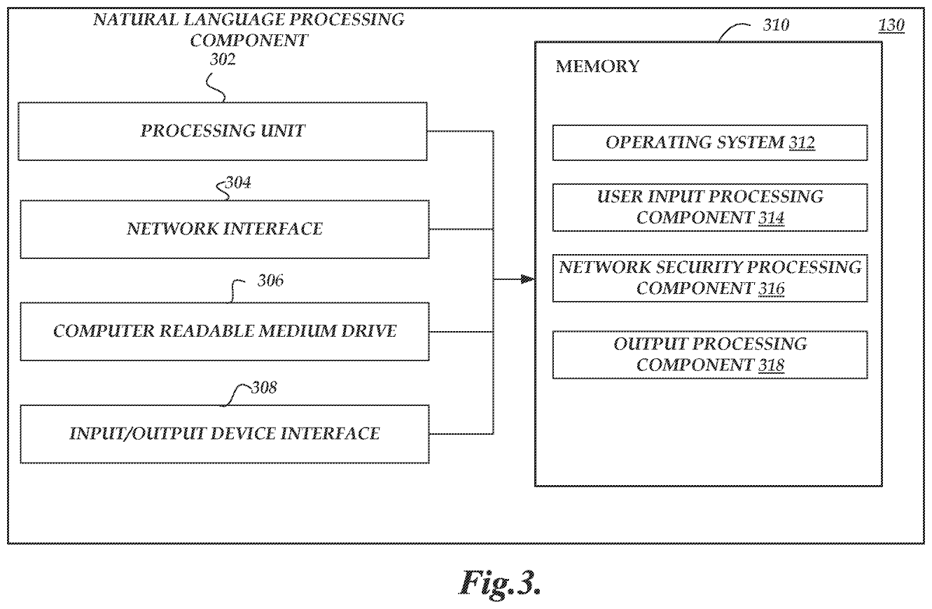

FIG. 3 depicts an example architecture of a NL processing component 130 that can be used to perform one or more of the techniques described herein. The general architecture of the NL processing component 130 depicted in FIG. 3 includes an arrangement of computer hardware and software modules that may be used to implement one or more aspects of the present disclosure. The NL processing component 130 may include many more (or fewer) elements than those shown in FIG. 3. It is not necessary, however, that all of these elements be shown in order to provide an enabling disclosure. As illustrated, the NL processing component 130 includes a processing unit 302, a network interface 304, a computer readable medium drive 306, and an input/output device interface 308, all of which may communicate with one another by way of a communication bus. The network interface 304 may provide connectivity to one or more networks or computing systems, including network 106. The processing unit 302 may thus receive information and instructions from other computing systems or services via a network (e.g., connecting the network-based service 110 and the environment 100).

The processing unit 302 may also communicate with memory 310. The memory 310 may contain computer program instructions (grouped as modules or units in some embodiments) that the processing unit 302 executes in order to implement one or more aspects of the present disclosure. The memory 310 may include random access memory (RAM), read only memory (ROM), and/or other persistent, auxiliary, or non-transitory computer readable media. The memory 310 may store an operating system 312 that provides computer program instructions for use by the processing unit 302 in the general administration and operation of the NL processing component 130. The memory 310 may further include computer program instructions and other information for implementing one or more aspects of the present disclosure.

In addition to and/or in combination with the operating system 312, the memory 310 includes a user input processing component 314, a network security processing component 316, and an output processing component 318, which may implement the functionality of the present disclosure. Illustratively, the user input processing component 314 can process NL-based inputs from client devices 102 and generate network security processing parameters. The user input processing component 314 illustratively implements one or more ML-based models, including LLMs, for processing the NL-based inputs and determining the network security processing parameters as described herein. The network security processing component 316 can identify one or more network security actions to be implemented by the network-based service 110 based on the network security parameters derived from the NL inputs. The network security processing component 316 illustratively implements one or more ML-based models for processing the NL-based determining the network security processing actions as described herein. The output processing component 318 can process processing results from the network security processing actions and generate outputs. The output processing component 318 illustratively implements one or more ML-based models, including LLMs, for generating the NL-based outputs as described herein.

While the user input processing component 314, the network security processing component 316, and the output processing component 318 are shown in FIG. 3 is part of the NL processing component 130, in other embodiments, all or a portion of the components may be implemented by another computing device. For example, in certain embodiments of the present disclosure, another computing device in communication the NL processing component 130 may include several modules or components that operate similarly to the modules and components illustrated as part of the NL processing component 130. In some instances, the components may be implemented as one or more virtualized computing devices. Moreover, components may be implemented in whole or part as a distributed computing system including a collection of devices that collectively implement the functions discussed herein.

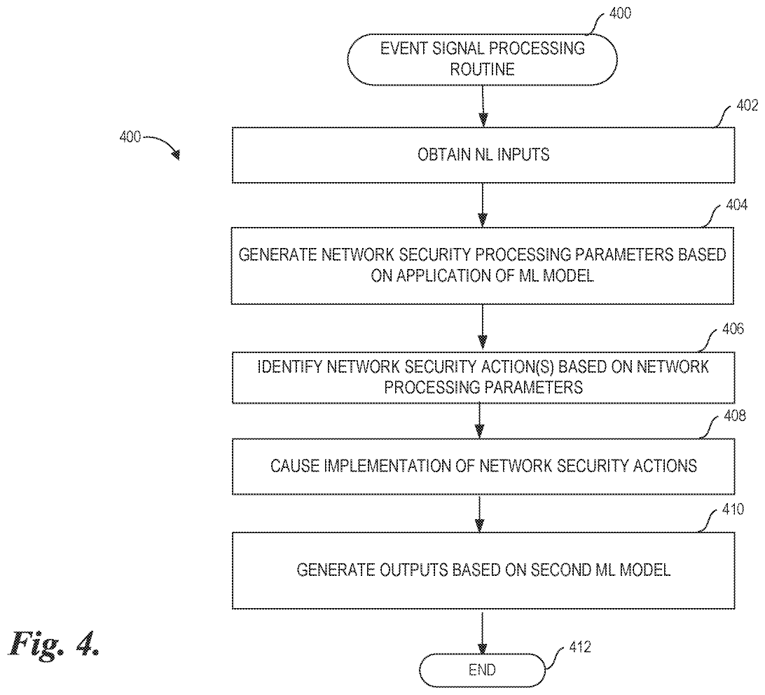

FIG. 4 is a flow diagram illustrative of a routine 400 for event signal processing. Routine 400 is illustratively implemented by the natural language processing component 130. At block 402, the natural language processing component 130 obtains natural language inputs from a client device 102. As previously discussed, by way of illustrative examples, in a security context, natural language inputs allow users to provide NL inputs regarding various aspects of network security to the ML-based architecture that can be used to extract information, derive network security processing attributes, network security actions based on the processing attributes, and generate outputs, including NL outputs. The types of network security actions include, but are not limited to, queries on raw data collected by the ML-based architecture, queries on network performance metrics, queries on cognitive structures or mental models implemented by the ML-based architecture, queries on previously performed or desired network security analytics, queries on newly created analysis, metrics, etc., and various combinations or alternative thereof.

At block 404, the natural language processing component 130 processes the natural language inputs and generates network security processing parameters based on application of a first machine learning model. Illustratively, network security processing parameters can correspond to a variety of information that can be extracted or correlated from the natural language inputs. The network security processing parameters to extract from the NL inputs can include data sources, objects, breakdowns, criteria/filters, timing information, breakdowns, actions, metrics, and the like. Accordingly, in some embodiments, the network security processing parameters include an identification of one or more data sources to be accessed by the network service. In other embodiments, the network security processing parameters include an identification of at least one network security processing action to be implemented by the network service. In still other embodiments, the network security processing parameters include an identification of criteria for searching data sources accessed by the network service. Still further, the network security processing parameters include an identification of an output to be generated in response to the natural language input. By way of illustration, the processing of the natural language inputs allows for the specification of workflows and actions related to network security data and analytics. The first machine learning model may be an LLM.

At block 406, the natural language processing component 130 identifies one or more network security actions based on the identified network security processing parameters. Illustratively, the one or more network security actions can be correlated with identified network security processing parameters to allow the natural language processing component 130 to transmit a set of requests to the network-based service 110. For example, the network security actions can include the generation of criteria or search commands that can elicit lexical search, semantic search, and knowledge summarization of data stores or information accessible to the network service. The natural language processing component 130 can, for example, supplement NL inputs to provide additional or alternative context for the network security actions by adding additional information from user profiles, external information, historical records, and the like. The one or more security actions can also be correlated to the NL inputs by identifying the type of output generated by different processes implemented the network-based service 110 as desired or necessary to be responsive to the NL input. The one or more security actions can also include specific configurations of available analytics provided by the network-based service 110 or the generation of new or alternative analytics. Illustratively, the natural language processing component 130 can implement various ML models that can receive the network security processing parameters as inputs and generate the network security actions (including commands, configurations, identifiers, etc.) as outputs.

At block 408, the natural language processing component 130 causes implementation of one or more network security actions implemented by a network-based service 110. Illustratively, the natural language processing component 130 can transmit or access the network-based service 110 via one or more application programming interfaces (APIs). Illustratively, the implementation of the one or more network security actions by the network-based service 110 causes the generation of processing results at (5). The processing results can generally represent any type of output or additional action that is generated based on the submission of the request to the network-based service 110. In the process illustrated in FIG. 2A, the processing result is a singular action of output generated by the network-based service 110. However, in other embodiments, the initial processes of the network security actions can cause the network-based service 110 to implement additional or repetitive processes, such as utilizing the outputs from a first set of network security actions as inputs to a second set of network security actions, etc. One skilled in the relevant art will appreciate, however, that the identified network security actions are illustrative in nature and should not be construed as limiting.

At block 410, the natural language processing component 130 generates natural-language based outputs based on application of the processing results according to a second machine learning model. Illustratively, network security processing parameters can correspond to a variety of information that can be extracted or correlated from the NL inputs. The outputs generated by the natural language processing component 130 can include various forms of structured text, data tables, graphs, images, videos, and the like. The outputs can also be processed based on role of the individual, such as for filtering information according to data rights, permissions, or authentications, organizing the data based on a decision making responsibility (e.g., presenting information according to the decision that is to be elicited), personal preferences, legal requirements (e.g., regulatory requirements), and the like. The second machine learning model may be an LLM. Routine 400 terminates at block 412.

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be fully automated via software code modules, including one or more specific computer-executable instructions executed by a computing system. The computing system may include one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of external computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. A computing environment can include any type of computer system, including, but not limited to, a computer system based on a microprocessor, a mainframe computer, a digital signal processor, a portable external computing device, a device controller, or a computational engine within an appliance, to name a few.

Conditional language such as, among others, “can,” “could,” “might,” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code that include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

What is claimed is:

1. A system comprising:
a user input processing module implemented on a processor in communication with a memory, wherein the processor is to execute specific computer-executable instructions to process natural language based inputs and generate network security processing parameters based on application of a first machine learning model;
a network security processing module implemented on a processor in communication with a memory, wherein the processor is to execute specific computer-executable instructions to identify one or more network security processing actions implemented by a network service, the one or more network security processing actions based on the generated network security processing parameters, wherein implementation of the one or more network security processing actions by the network service causes the generation of processing results; and
an output processing module implemented on a processor in communication with a memory, wherein the processor is to execute specific computer-executable instructions to process the generated processing results and generate natural-language based outputs based on application of a second machine learning model.

2. The system of claim 1, wherein the network security processing parameters include an identification of one or more data sources to be accessed by the network service.

3. The system of claim 1, wherein the network security processing parameters include an identification of criteria for searching data sources accessed by the network service.

4. The system of claim 3, wherein the criteria include timing information.

5. The system of claim 1, wherein the network security processing parameters include an identification of at least one network security processing action to be implemented by the network service.

6. The system of claim 5, wherein the one or more network security processing action includes a request for a system analysis to be implemented by the network service.

7. The system of claim 1, wherein the network security processing parameters include an identification of an output to be generated in response to a natural language input.

8. A computer-implemented method comprising:
receiving a natural language based input;
generating network security processing parameters based on application of a first machine learning model;
causing implementation of one or more network security actions implemented by a network service, the one or more network security actions based on the generated network security processing parameters, wherein implementation of the one or more network security actions by the network service causes generation of processing results; and
generating natural-language based outputs based on application of the processing results according to a second machine learning model.

9. The computer-implemented method of claim 8, wherein the network security processing parameters include an identification of one or more data sources to be accessed by the network service.

10. The computer-implemented method of claim 8, wherein the network security processing parameters include an identification of criteria for searching data sources accessed by the network service.

11. The computer-implemented method of claim 10, wherein the criteria include criteria for searching data sources.

12. The computer-implemented method of claim 10, wherein the criteria include criteria for searching raw metric data.

13. The computer-implemented method of claim 10, wherein the criteria include criteria for searching network security analytics.

14. The computer-implemented method of claim 8, wherein the network security processing parameters include an identification of at least one network security processing action to be implemented by the network service.

15. The computer-implemented method of claim 14, wherein the network security action includes a request for a system analysis to be implemented by the network service.

16. The computer-implemented method of claim 8, wherein at least the first machine learning model or the second machine learning model correspond to large language models.

17. A system comprising:
a natural language processing component to process natural language based inputs and generate network security processing parameters based on application of a first machine learning model and identify one or more network security actions implemented by a network service, the one or more network security actions based on the generated network security processing parameters; and
a network security processing service to receive the network security action and implement one or more network security processing actions by the network service and responsive processing results; and
wherein the natural language processing component processes the generated processing results and generates natural-language based outputs based on application a second machine learning model.

18. The system of claim 17, wherein the network security processing parameters include an identification of one or more data sources to be accessed by the network service.

19. The system of claim 17, wherein the network security processing parameters include an identification of criteria for searching data sources accessed by the network service.

20. The system of claim 17, wherein the network security processing parameters include an identification of at least one network security processing action to be implemented by the network service.

21. The system of claim 17, wherein the network security processing parameters include an identification of an output to be generated in response to the natural language input.
